(19) United States
(12) Patent Application Publication
(10) Pub. No.: US 2024/0024947 A1
(43) Pub. Date: Jan. 25, 2024

(54) CASING FOR SEALER

(71) Applicant: FERRUM PACKAGING AG, Schafisheim (CH)

(72) Inventors: Peter STOLTENBERG, Aarau (CH); Jörn WINKELMANN, Barmstedt (CH); Günter HELL, Zetzwil (CH)

(21) Appl. No.: 18/218,524

(22) Filed: Jul. 5, 2023

(30) Foreign Application Priority Data
Jul. 19, 2022 (EP) 22185619.8

(51) Int. Cl. B21D 51/32

(52) U.S. Cl. CPC B21D 51/32

(57) ABSTRACT

A sealer for sealing a container includes a machine bottom part for arranging the sealer on a ground, a working space, the container capable of being sealed in the working space, a casing surrounding the working space and arranged on the machine bottom part, and a machine upper part with elements to seal the container, the machine upper part arranged on the casing in such a way that the machine upper part is supported on the machine bottom part via the casing and the elements to seal the container are arranged in the working space.

### CROSS-REFERENCE TO RELATED APPLICATION

This application claims priority to European Patent Application No. 22185619.8, filed Jul. 19, 2022, the contents of which are hereby incorporated by reference in its entirety.

### BACKGROUND

### Technical Field

The disclosure relates to a sealer for sealing a container. The disclosure further relates to a method for sealing a container with a sealer according to the disclosure.

### Background Information

When filling beverage cans or food cans, the cans pass through a can sealer after being filled with the beverage or food, wherein the filled can bodies enter via a feed path and can lids enter via a further feed path. The can sealer usually has several similar stations arranged in a carousel shape, in each of which a can is sealed by a can lid. The can lids are guided onto the can bodies and held on the can body with a holding plate of a seaming head. This holding also serves to fix the cans against breaking out of the circular path through which the cans pass in the can sealer due to the centrifugal force. In the can sealer, the can bodies with the can lid are seamed over a seaming roll at the edges and thus sealed. Normally, the can with the can lid is additionally rotated around its own axis of symmetry by the seaming head, For rotation, the seaming heads are arranged on a respective seaming shaft. The seaming rolls are arranged on a seaming lever by seaming lever shafts.

A generic can sealer is described in DE 749636 and DE 4234115 A1. The can sealer comprises a clamping device for receiving a can to be sealed. In the operating state, the can to be sealed is introduced into the clamping device and secured by the damping device in the axial and radial directions. A can lid is also introduced centered over the can opening of the can to be sealed. The can has a circumferential can flange in the area of the can opening and the can lid has a circumferential can lid flange. For sealing the can opening by the can lid, the can sealer additionally comprises two seaming rolls, each mounted rotatably about an axis, which press the can flange and the can lid flange together by a force acting substantially radially, the pressing being effected by a continuous rolling in the circumferential direction along the circumference of the can opening.

A further can sealer is known from GB 2098899 A. The can sealer comprises a clamping device for receiving the can to be sealed and a seaming roll. In the operating state, the can to be sealed is introduced into the damping device and secured by the clamping device in the axial and radial directions. A can lid is also introduced centered over the can opening of the can to be sealed. The can has a circumferential can flange in the area of the can opening of the can body and the can lid has a circumferential can lid flange.

For a better understanding of the subject matter of the present disclosure, a conventional can sealer known from the state of the art is described in the following on the basis of FIGS. 1 and 2.

For a better distinction of the known state of the art from the present disclosure, reference signs to features of known devices are provided with an inverted comma (in FIGS. 1, 2 and 7A) in the context of this application, whereas features to devices according to the disclosure or their components do not carry an inverted comma.

The conventional can sealer 1000′ according to FIG. 1 comprises a lid feeding device 11′ for feeding a lid 101′ to the can, a gassing rotor 15′ for feeding gas to the can, and a seaming process 14′ for sealing the can with the lid 101′.

The lid 101′ is introduced into the can sealer 1000′ along the arrow C′ by the lid feeding device 11′. In doing so, the lids 101′ are arranged on the gassing rotor 15′. The lids 101′ are transported further by rotation of the gassing rotor 15′. Then, the cans are introduced by the container feed 12′ into the container receptacles 17′ of the gassing rotor 15′. There, the can is gassed in area D′ with a gas such as carbon dioxide or nitrogen and combined with the lid 101′.

The gassing takes place along the arrow B′ with the gas feed 16′. After gassing, the can with the lid 101′ is transported further by the container transfer 13′ from the gassing rotor 15′ to the seaming process 14′ and is sealed there.

The cans are clamped between a machine bottom part 4′ and a machine upper part 5′ on a rotor 42′ of the seaming process 14′ and are sealed by the seaming process 14′. The sealed can is conveyed by another rotor into the can outlet 18′.

The can sealer 1000′ according to FIGS. 1 and 2 comprises both a housing 1′ which surrounds a working space 2′, and supporting structures 3′.

The machine upper part 5′ is positioned on several cylindrical telescopic columns 3′ as supporting structures. The machine upper part 5′ is adjusted in height depending on a container to be processed (i.e., can and lid). The cans are open during the transport into the can sealer 1000′. For this reason, the entire working space 2′ is a hygiene zone. For this reason, the can sealer 1000′ is provided with the housing/the covering 1′ to separate the hygiene zone and to ensure personal safety. This covering 1′ is attached to the machine bottom part 4′ and comprises the entire working space 2′ including the machine upper part 5′.

### SUMMARY

It has been determined that this leads to a large volume to be cleaned and a large surface to be cleaned. The telescopic columns 3′, which support the machine upper part 5′, also lead to spray shadows. Spray shadows are areas behind objects that are not or insufficiently reached or cleaned by the cleaning process. As a consequence, a complex nozzle system is required for cleaning.

A major disadvantage of the conventional devices is therefore that the working space is large and difficult to clean.

It is therefore the object of the disclosure to provide a sealer which avoids the disadvantageous effects known from the state of the art. In particular, a sealer with the smallest possible working space should be provided, which is additionally easy to clean.

The object is met by a sealer according to the disclosure and by the method according to the disclosure.

According to the disclosure, a sealer for sealing a container is proposed. Here, the sealer comprises a machine bottom part for arranging the sealer on a ground (or a bottom) and a working space, in which working space the container is sealed. In addition, the sealer comprises a casing surrounding the working space and arranged on the machine bottom part and a machine upper part with elements for sealing the container. The machine upper part is arranged on the casing in such a way that the machine upper part is supported on the machine bottom part via the casing and the elements for sealing the container are arranged in the working space.

Due to the arrangement described above, the casing at least partially fulfills the function of the telescopic columns and covering known from the state of the art. Thus, the casing functions in particular as a supporting structure and separates simultaneously the working space of the sealer (and enables thus the formation of a hygiene zone). The telescopic function can be realized by a lifting drive arranged outside the working space, which enables a height adjustment.

In particular, the casing can be considered as a housing, covering, enclosure or sheathing section or element that at least partially surrounds the working space and supports the machine upper part. The casing can be arranged exclusively around the working space, i.e., the casing does not comprise any part which is arranged in the working space. In addition, the casing can close off and/or shield the working space from the outside as far as possible, so that an atmosphere in the working space is hygienically separated from the surroundings. Of course, however, openings can be provided for feeding and discharging the container.

In this regard, the working space is the space of the sealer in which the container is preferably sealed with a lid, in particular the space in which a seaming process takes place. In addition, the working space can preferably be arranged between the machine upper part and the machine bottom part.

“To support” can be understood to mean that the casing holds or supports the machine upper part on the machine bottom part. Thus, a weight of the machine upper part rests on the machine bottom part since the machine upper part is supported on the machine bottom part via the casing.

The machine upper part can be attached to the casing in such a way that the machine upper part is supported on the machine bottom part via the casing.

In addition or as an alternative, the machine upper part can be arranged on the casing in such a way that the machine upper part is exclusively supported on the machine bottom part via the casing (i.e., the entire weight of the machine upper part is carried by the casing and supported on the machine bottom part/there are no additional supports for the machine upper part). In particular, no further supporting columns/supports are thus arranged in the working space to support the machine upper part.

In addition, the casing can be attached to the machine bottom part (e.g., by a plug-in and/or screw connection). However, as an alternative, the machine bottom part can be an integral component of the casing, so that the casing comprises the machine bottom part in the form of supports. However, the casing is preferably a separate component.

In an embodiment of the disclosure, the machine bottom part can comprise a support plate and the casing can be arranged on the support plate (respectively onto) in such a way that the machine upper part is supported on the support plate via the casing. In addition, the casing can comprise a mounting plate and the machine upper part can be arranged on the mounting plate.

In a particularly preferred embodiment, the mounting plate can comprise a mounting opening and the machine upper part can be arranged (and/or attached) in the mounting opening in such a way that the machine upper part projects at least partially into the working space. Thus, a first section of the machine upper part can project into the working space/be arranged in the working space, while a second part (different from the first) of the machine upper part is arranged outside the working space. The first part of the machine upper part would then be arranged on a first side (facing the working space) of the mounting plate, while the second part of the machine upper part is arranged on a second side (different from the first and facing away from the working space) of the mounting plate. To seal the two sides of the mounting plate from each other, a seal can be used when arranging the machine upper part in the mounting opening, which seals between the machine upper part and the mounting opening.

The machine upper part can comprise a sealing head as an element for sealing the container, in particular a plurality of sealing heads for attaching a lid on the container (i.e., for sealing the container with the lid) as elements for sealing. Particularly preferably, the first section of the machine upper part comprises the sealing heads. The sealing head can comprise seaming means for seaming the lid to the container. The seaming means can be a seaming roll and a seaming head. Thus, the or each sealing head can comprise at least one seaming roll (particularly preferably two seaming rolls) and one seaming head. The sealing head can comprise a seaming roll rotatable about a seaming axis, wherein the seaming head is arranged at one end of the respective seaming roll (i.e., the seaming head can be rotated in particular by the respective seaming roll). The seaming rolls are preferably arranged on a seaming lever via seaming lever shafts.

In principle, the machine upper part preferably comprises the device parts that have direct contact with the lid and opening area of the container, while the machine bottom part preferably exclusively comprises device parts that do not have direct contact with the lid and opening area of the container.

In addition, the machine upper part can comprise an ejection element arranged on the seaming shaft (of the seaming head), and the ejection element can be arranged movably along the seaming axis in such a way that the container can be ejected in the operating state.

In an embodiment of the disclosure, the support plate can be arranged opposite from the mounting plate so that the working space is arranged between the support plate and the mounting plate and is formed in particular between the casing, support plate and mounting plate. The support plate can be arranged parallel to the mounting plate.

The sealer according to the disclosure can further comprise a lifting station (or a plurality of lifting stations) for lifting the container. The tilling stations can be arranged opposite the sealing heads on the machine bottom part, in particular on the support plate.

The casing can comprise a door, in particular a plurality of doors arranged on different sides of the casing. In this way, the working space can be made accessible for maintenance or cleaning work, for example. The doors can be sliding doors, lifting doors and/or doors attached on one side.

In practice, the sealer can comprise a container feed for feeding the containers (such as a feeding table) to the working space and a container discharge for discharging the containers from the working space. A separating wall or a screen can be arranged between the container feed and the container discharge, which avoids a cross-contamination between incoming and outgoing containers.

According to the disclosure, a method for attaching a lid to a container (i.e., for sealing the container with the lid) is further proposed. In this regard, the method according to the disclosure comprises providing a sealer according to the disclosure. Here, the lid and the container are fed to the working space. Then, the lid is positioned on the container and the container is sealed with the lid. Then, the sealed container is discharged from the working space.

In particular, the sealing process can comprise the seaming of the lid to the container by at least one seaming roll, in particular two seaming rolls, and one seaming head.

The sealer according to the disclosure is preferably designed as a can sealer. The can sealer usually has several similar stations (of preferably sealing heads and lifting stations) arranged in a carousel shape, in which a can can be sealed in each case with a can lid.

Here, the container can be a can and the lid can be a can lid, which are seamed together by the can sealer.

For sealing the can, the can sealer preferably comprises several sealing heads (as described above with several seaming rolls and one seaming head). In the operating state, the seaming rolls with their respective seaming profile are brought into contact with a can lid flange of the can lid and a can flange of the can. By rotating the can, the seaming roll is then rotated in the circumferential direction of the can, thereby seaming the can flange with the can lid flange, For rotation of the can, the can is preferably clamped between the seaming head and a support (in particular the lifting station), whereby the seaming head is rotated about the seaming axis by the seaming shaft.

In the context of the disclosure, the can can be understood to be a rotationally symmetrical container which is sealed by the can sealer and the associated seaming roll. A can can preferably comprise a metal, in particular aluminum or steel.

The sealer according to the disclosure can comprise the carousel with a plurality of sealing heads as the seaming process. In addition, the sealer can comprise a first inlet for can bodies, in particular can bodies filled with a product, to the carousel and a second inlet for can lids to the carousel. In addition, the sealer can comprise an outlet for seamed cans from the carousel.

In principle, the sealer according to the disclosure can be analogous to the can sealers already known from the state of the art but differs in the casing.

In practice, as in the state of the art, the can sealer preferably comprises a clamping device made of a seaming head and a lifting station, with which the can is fixed in the axial and radial direction for sealing and can be rotated in the circumferential direction.

In principle, the sealer can preferably comprise at least two types of seaming rolls with preferably different seaming profiles (wherein the corresponding sealing head comprises seaming rolls of both types), so that cans can be sealed according to a double-seam principle, in which the cans are generally sealed in two stages. One type of seaming roll is responsible for one stage. The first type of seaming roll makes a pre-seam, while the second type of seaming roll completely seals the can/package.

In the method according to the disclosure, can lids and can bodies can be brought together at a defined point before the actual seaming process. The feeding of the can lids is preferably carried out by a gassing rotor on which the can lids rest. The can bodies are fed by a container feed. The can bodies pass from the container feed to one of the respective lifting stations (which are integrated into the carousel). On one revolution of the carousel, the lifting stations preferably perform a cam-controlled lifting motion to feed the can bodies from below to the can lids and later the seaming head.

After a certain lifting path, the can body contacts the can lid. The ejection elements are preferably used so that the composite of can body and can lid can make the rest of the rise together.

The ejection element is attached, for example, to an ejection rod which makes a linear movement along the axial direction within a seaming shaft (the seaming head is attached to this seaming shaft). Preferably cam-controlled, the can lid is first clamped in the lid feed during the downward movement. As soon as the can body is moved into the can lid, the ejection element changes the direction of the lift and moves upwards evenly with the lifting station. The supporting function of the ejection element ends when the can body and can lid are moved into the seaming head. From this moment on, the can is clamped between the lifting station and the seaming head. Subsequently, the actual seaming process is carried out.

### BRIEF DESCRIPTION OF THE DRAWINGS

In the following, the disclosure and the state of the art are explained in more detail based on embodiments with reference to the drawings.

FIG. 1 illustrates a top view of a can sealer of the state of the art;

FIG. 2 illustrates a side view of a can sealer of the state of the art;

FIG. 3 illustrates a top view of a can sealer according to the disclosure;

FIG. 4 illustrates a first perspective view of the can sealer according to the disclosure;

FIG. 5 illustrates a second perspective view of the can sealer according to the disclosure;

FIG. 6 illustrates a schematic view of a sealing head;

FIG. 7A illustrates a top view of a can sealer of the state of the art with the doors open;

FIG. 7B illustrates a top view of a can sealer according to the disclosure with the doors open.

### DETAILED DESCRIPTION

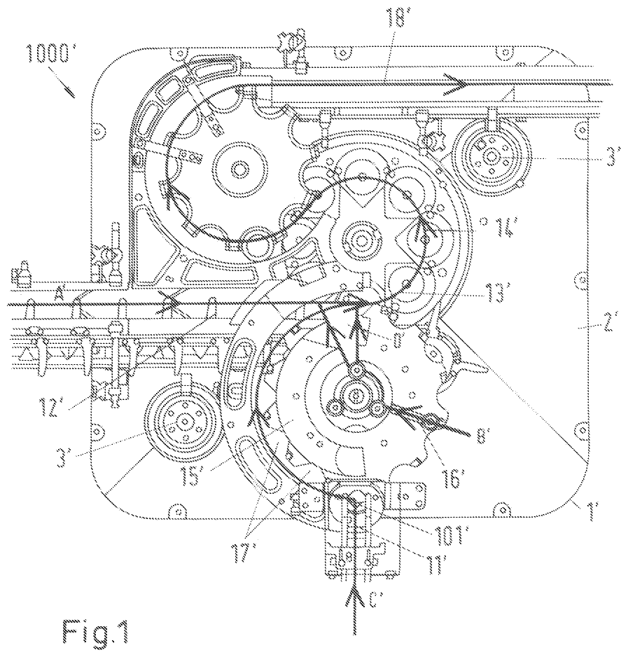

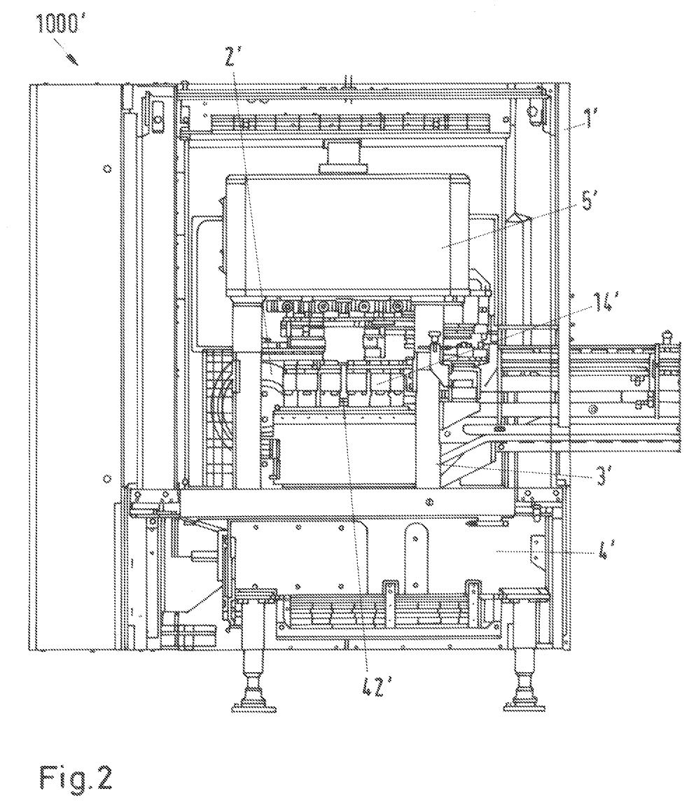

FIG. 1 and FIG. 2 have already been described above in the representation of the state of the art.

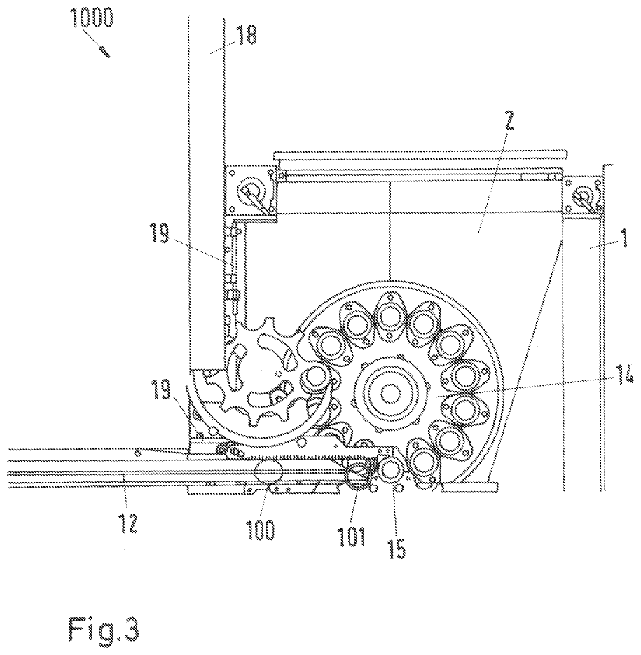

FIG. 3 shows a top view of a can sealer 1000 according to the disclosure. In principle, the sealing process is carried out analogously to the state of the art, i.e., analogous as described in FIGS. 1 and 2.

Thus, the can sealer 1000 for sealing, a can 100 comprises a lid feed for feeding a lid 101 to the can 100 ; a gassing rotor 15 (only partially represented) for feeding gas to the can 100, and a seaming process/a seaming station 14 for sealing the can 100 with the lid 101.

When the lid 101 and can 100 are united, the can is gassed with a gas such as carbon dioxide or nitrogen and moved on to the seaming process 14 and sealed there.

The can sealer 1000 according to the disclosure comprises a casing 1 which surrounds a working space 2, in which the seaming process/the seaming station 14 is arranged (i.e., the cans are sealed). In doing so, a volume to be cleaned as well as a surface to be cleaned can be kept as minimal as possible. Telescopic columns in the working space 2 for supporting a machine upper part are not required, and spray shadows and an elaborate cleaning system can thus be avoided.

The sealed cans are conveyed out of the working space 2 by a traction element such as a flat-top chain of a container discharge 18, As the fiat-top chain returns, contaminants can be introduced into the working space 2 and thrown toward the open can.

For this reason, the container discharge 18 is sealed off from the working space 2 and the container feed 12 by separating walls 19 with breaches. In this way, contaminants being carried into the working space 2 and towards the open can can be prevented.

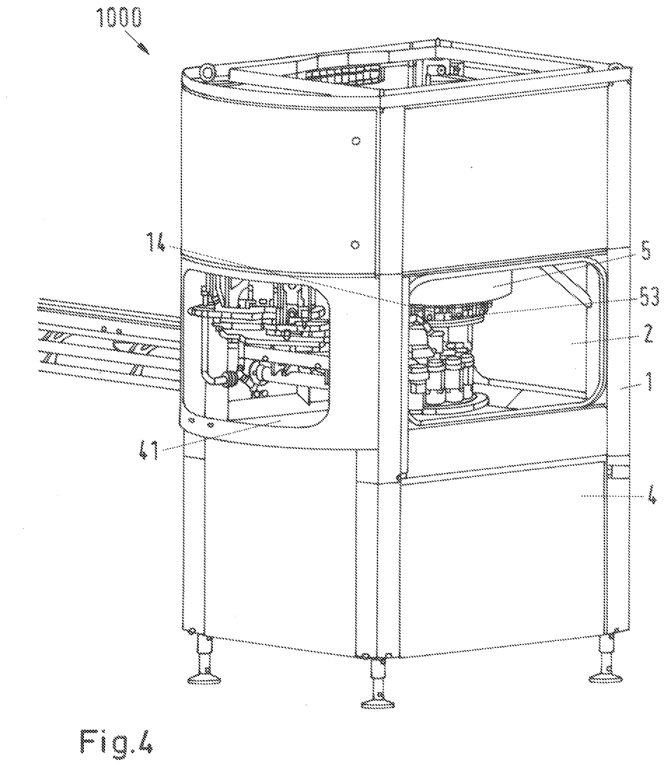

FIG. 4 shows a first perspective view of the can sealer 1000 according to the disclosure.

The can sealer 1000 comprises a machine bottom part 4 for arranging the can sealer 1000 on a ground (or a bottom) and the working space 2, in which working space 2 the cans are sealed. In addition, the can sealer 1000 comprises the casing 1 surrounding the working space 2 and arranged on the machine bottom part 4 and the machine upper part 5 with sealing heads 53 for sealing the cans, which are arranged in the working space 2. The machine upper part 5 is arranged on the casing 1 in such a way that the machine upper part 5 is supported on the machine bottom part 4 via the casing 1.

Instead of telescopic columns for attaching the machine upper part 5 and a comprehensive covering as a protective device, the casing 1 according to the disclosure fulfills a combination of these two functions. The supporting structure of the can sealer 1000 as well as the shielding of the working space 2 (also product space) is thus realized with the casing 1.

The machine upper part 5 is supported on the machine bottom part 4 exclusively via the casing 1 (i.e., the entire weight of the machine upper part 4 is carried by the casing 1 and supported on the machine bottom part 4, although a rotor element of the carousel is still arranged between the machine upper part 5 and the machine bottom part 4).

For this purpose, the machine bottom part 4 comprises a support plate 41 on which the casing 1 is supported or is supported on supports of the machine bottom part 4 and comprises a trough structure 41 which is part of the working space 2.

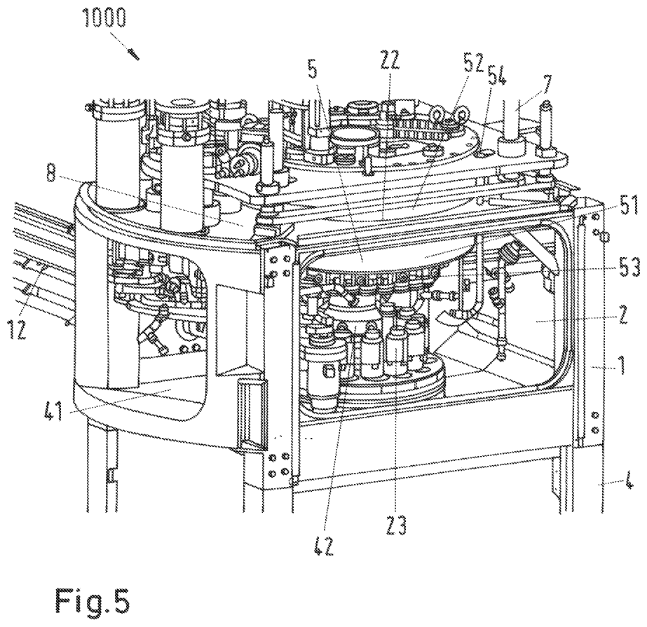

FIG. 5 shows a second perspective view of the can sealer 1000 according to the disclosure.

In the process for sealing the cans, lids are fed to the cans, the cans are clamped between a machine bottom part 4 and the machine upper part 5 on a rotor 42 and are sealed by the sealing heads 53. The sealed can is conveyed by another rotor to the container discharge.

The cans are open during transport in the can sealer 1000, which is why the entire working space 2 is to be understood as a hygiene zone. The machine is equipped with the casing 1 to separate the hygiene zone and to ensure personal safety.

As described above, the machine bottom part 4 comprises the support plate 41. However, the machine bottom part 4 can preferably be an integral part of the casing 1 such that the support plate 41 would be considered a bottom surface 41 of the working space 2 or the trough structure.

In addition, the casing 1 comprises a mounting plate 8 with a mounting opening 22. Here, the machine upper part 5 is arranged in the mounting opening 22 in such a way that the machine upper part 5 partially projects into the working space 2. A first section 51 of the machine upper part 5 thus projects into the working space 2, while a second section 52 of the machine upper part 5 is arranged outside the working space 2. The sealing heads 53 are thereby arranged on the first section 51.

On the other hand, the second section 52 is attached to the casing 1. For this purpose, the second section 52 is screwed to an intermediate plate 54, which is supported on the mounting plate 8 of the casing 1.

In addition, the machine upper part 5 comprises a lifting mechanism 7. The components relevant to the seaming process project into the working space 2 through the mounting plate 8, which is firmly connected to the supporting casing 1. The opening 22 and the other breaches are sealed by wipers. Due to the lifting mechanism 7, the machine upper part 5 can be adjusted to the correct height depending on the package to be processed.

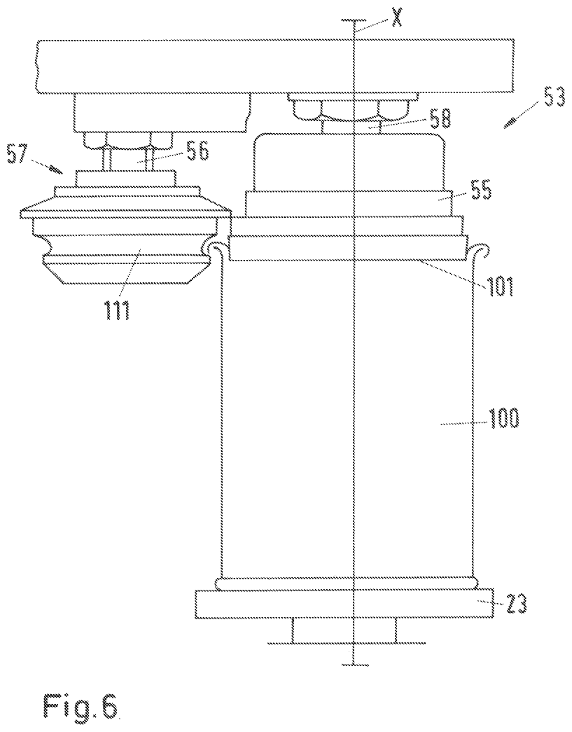

FIG. 6 shows a schematic view of a sealing head 53 with a can 100 to be sealed and a can lid 101.

In addition, a clamping device is shown which comprises a can support with lifting station 23 and a seaming head 55, and a seaming roll 57 rotatably mounted about a seaming shaft 56 and having a seaming roll profile 111. The can lid 101 is arranged centered above the can opening 100. The can 100 has a circumferential can flange in the area of the can opening, and the can lid 101 has a circumferential can lid flange.

During the sealing process, the seaming roll 57 is brought into contact with the can flange and the can lid flange via the seaming roll profile 111. In this process, the can flange and the can lid flange are pressed together via the seaming roll 57 by a force acting substantially radially. The pressing is effected by a continuous rolling of the seaming roll 57 in the circumferential direction along the circumference of the can opening. By seaming the can 100 with the can lid 101, a double seam is preferably made. For this purpose, however, a second seaming roll not shown here is used.

For seaming, the can 100 is rotated by the clamping device by rotating the seaming head 55 by the seaming shaft 58 about the seaming axis X.

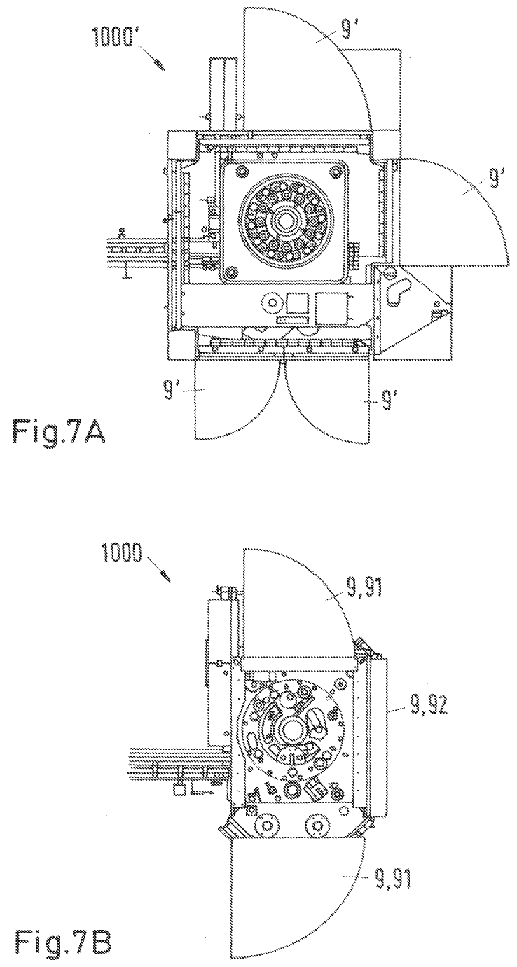

FIG. 7A shows a top view of a can sealer 1000 of the state of the art with the doors 9′ open.

The space required for the telescopic columns 3′ and the covering 1′ lead to the fact that the machine operator for adjustment work sometimes stands far away from the components to be adjusted. The freedom of movement around the sealer during adjustment work is restricted by the open doors 9′. The operator must walk around the doors 9′.

This can be avoided by the can sealer 1000 according to the disclosure with doors 9 according to FIG. 7B.

The accessibility for adjustment work is significantly improved by the use of doors 91 with one-sided attachment and a lifting door 92, which improve the freedom of movement around the sealer 1000.

The disclosure is not limited to the disclosed embodiments. Other variations of the disclosed embodiments can be understood and effected by persons skilled in the art in practicing a claimed disclosure from a study of the drawings, the disclosure, and the dependent claims. In the claims, the word “comprising” does not exclude other elements or steps, and the indefinite article “a” or “an” does not exclude a plurality. The mere fact that certain measures are repeated in mutually different dependent claims does not mean that a combination of these measures cannot be advantageously used. Any reference signs in the claims should not be interpreted as limiting the scope.

In all embodiments, the machine upper part is preferably supported on the machine bottom part exclusively via the casing and not by any other supports apart from the casing. The casing surrounds the working space, i.e., the space in which the sealing process/seaming process takes place.

1. A sealer for sealing a container comprising:
a machine bottom part for arranging the sealer on a ground;
a working space, the container capable of being sealed in the working space;
a casing surrounding the working space and arranged on the machine bottom part; and
a machine upper part with elements to seal the container,
the machine upper part arranged on the casing in such a way that the machine upper part is supported on the machine bottom part via the casing and the elements to seal the container are arranged in the working space.

2. The sealer according to claim 1, wherein the machine upper part is attached to the casing in such a way that the machine upper part is supported on the machine bottom part via the casing.

3. The sealer according to claim 1, wherein the machine upper part is arranged on the casing in such a way that the machine upper part is exclusively supported on the machine bottom part via the casing.

4. The sealer according to claim 1, wherein the machine bottom part comprises a support plate and the casing is arranged on the support plate in such a way that the machine upper part is supported on the support plate via the casing.

5. The sealer according to claim 1, wherein the casing comprises a mounting plate and the machine upper part is arranged on the mounting plate.

6. The sealer according to claim 5, wherein the mounting plate comprises a mounting opening and the machine upper part is arranged in the mounting opening in such a way that the machine upper part projects into the working space.

7. The sealer according to claim 4, wherein the support plate is arranged opposite from the mounting plate so that the working space is arranged between the support plate and the mounting plate.

8. The sealer according to claim 1, wherein the machine upper part comprises a sealing head to attach a lid on the container.

9. The sealer according to claim 8, wherein the sealing head comprises a seaming device configured to seam the lid to the container.

10. The sealer according to claim 9, wherein the seaming device comprises a seaming roll and a seaming head (55).

11. The sealer according to claim 9, wherein the sealing head comprises a seaming shaft rotatable about a seaming axis (X) and the seaming device is arranged at one end of the seaming shaft.

12. The sealer according to claim 11, wherein the machine upper part comprises an ejecting element arranged on the seaming shaft and the ejecting element is movably arranged along the seaming axis (X) in such a way that the container is capable of being ejected in an operating state.

13. The sealer according to claim 1 comprising a lifting station to lift the container.

14. The sealer according to claim 13, wherein the lifting station is arranged on the machine bottom part.

15. The sealer according to claim 1, wherein the casing comprises a first door and a second door arranged on different sides of the casing.

16. The sealer according to claim 1 comprising a container supply configured to supply the container to the working space and a container discharge configured to discharge the container from the working space.

17. The sealer according to claim 16, wherein a separating wall is arranged between the container supply and the container discharge.

18. A method for sealing a container with a lid, comprising:
providing a sealer according to claim 1;
supplying the lid and the container to the working space;
positioning the lid on the container;
sealing the container with the lid; and
discharging the sealed containers from the working space.

19. The method according to claim 18, wherein the sealing comprises a seaming of the lid to the container by at least one seaming roll and a seaming head.

20. The sealer according to claim 1, wherein the machine upper part comprises a sealing a plurality of sealing heads to attach a lid on the container.
